(19) United States
(12) Patent Application Publication
(10) Pub. No.: US 2013/0008577 A1
(43) Pub. Date: Jan. 10, 2013

(54) WHEEL TRACTION ENHANCEMENT DEVICE

(76) Inventor: KEVIN G. RUESINK, Castlewood, SD (US)

(21) Appl. No.: 13/177,928

(22) Filed: Jul. 7, 2011

(51) Int. Cl. B60C 27/00

(52) U.S. Cl. 152/216

(57) ABSTRACT

A traction enhancement device for mounting on a wheel of a vehicle comprising a pair of traction assemblies each comprising a central structure for positioning adjacent to a wheel and a plurality of traction structures mounted on and radiating outwardly from the central structure. A mounting structure for releasably mounting the traction assemblies together may be configured to permit adjustment of a distance between the central structures of the traction assemblies. A biasing structure may be configured to selectively apply an inwardly directed force on the traction assemblies to bias the traction structures toward each other and against the circumferential surface of the wheel. At least one traction structure includes a rigid element configured to be positioned adjacent to the circumferential surface and a flexible element positioned along a portion of the rigid element to be positioned adjacent to the circumferential surface when the device is mounted on the wheel.

### BACKGROUND

1. Field

The present disclosure relates to wheel traction aids and more particularly pertains to a new wheel traction enhancement device for providing some of the advantages of the use of wheel chains to increase traction in a device that is easier and faster to mount on the wheel.

2. Description of the Prior Art

Wheel or tire chains have been used for years to increase the traction of a tire on surfaces that are relatively slippery compared to normal road pavement, such as ice, packed snow, mud, and the like. The wheel chains, while generally effective for increasing the traction of the wheel, are difficult to install on the wheel, requiring that the chains be untangled, laid out on the ground, and often requiring the wheel to be rolled forward during installation, before the installation is completed. This is difficult and inconvenient in the best of conditions, but is made more difficult by the conditions typically present when there is the need to use traction aids, such as cold, wet, snowy, windy and/or muddy conditions, particularly if the vehicle is already “stuck” due to the low traction conditions.

While other traction aids have been proposed as alternatives to the use of chains, these other designs are believed to have limitations in the ease of installation and/or effectiveness to overcome the low tractions conditions.

### SUMMARY

In view of the disadvantages inherent in the known types of traction aids now present in the prior art, the present disclosure describes a new wheel traction enhancement device which may be utilized for providing some of the advantages of the use of wheel chains to increase traction in a device that is easier and faster to mount on the wheel than conventional wheel chains.

In one aspect, the present disclosure relates to a traction enhancement device for mounting on a wheel of a vehicle, with the wheel being of the type having an outward side surface, an inward side surface, and a circumferential surface between the outward and inward side surfaces. The device may comprise a pair of traction assemblies for removably mounting on a wheel, with each of the traction assemblies comprising a central structure for positioning adjacent to a center of the outward side surface of the wheel and a plurality of traction structures mounted on the central structure and radiating outwardly from the central structure. The device may also include an adjustable mounting structure for releasably mounting the traction assemblies together, with the adjustable mounting structure being configured to permit adjustment of a distance between the central structures of the traction assemblies. The device may also include a biasing structure configured to selectively apply an inwardly directed force on the traction assemblies to bias the traction structures toward each other and against the circumferential surface of the wheel when mounted on the wheel. The at least one of the traction structures may include a rigid element configured to be positioned adjacent to the circumferential surface of the wheel when the device is mounted on the wheel and a flexible element positioned along a portion of the rigid element to be positioned adjacent to the circumferential surface of the wheel when the device is mounted on the wheel.

In another aspect, the present disclosure relates to a traction enhancement device for mounting on a wheel of a vehicle, with the wheel being of the type having an outward side surface, an inward side surface, and a circumferential surface between the outward and inward side surfaces. The device may comprise a pair of traction assemblies for removably mounting on a wheel, with each of the traction assemblies comprising a central structure for positioning adjacent to a center of the outward side surface of the wheel and a plurality of traction structures mounted on the central structure and radiating outwardly from the central structure. The device may also include an adjustable mounting structure for releasably mounting the traction assemblies together, with the adjustable mounting structure being configured to permit adjustment of a distance between the central structures of the traction assemblies. The at least one of the traction structures may include a rigid element configured to be positioned adjacent to the circumferential surface of the wheel when the device is mounted on the wheel and a flexible element positioned along a portion of the rigid element to be positioned adjacent to the circumferential surface of the wheel when the device is mounted on the wheel. The flexible element may comprise a chain removably mounted on the rigid element to permit interchange of the flexible element on the rigid element.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic perspective view of a new wheel traction enhancement device according to the present disclosure.

FIG. 2 is a schematic side view of the traction assemblies of the traction enhancement device, according to an illustrative embodiment.

FIG. 3 is a schematic exploded side view of the traction enhancement device, according to an illustrative embodiment.

FIG. 4 is a schematic side view of one of the traction assemblies of the wheel traction enhancement device, according to an illustrative embodiment.

FIG. 5 is a schematic end view of one of the traction assemblies of the device, according to an illustrative embodiment.

FIG. 6 is a schematic enlarged partial end view of the traction enhancement device, according to an illustrative embodiment.

### DETAILED DESCRIPTION

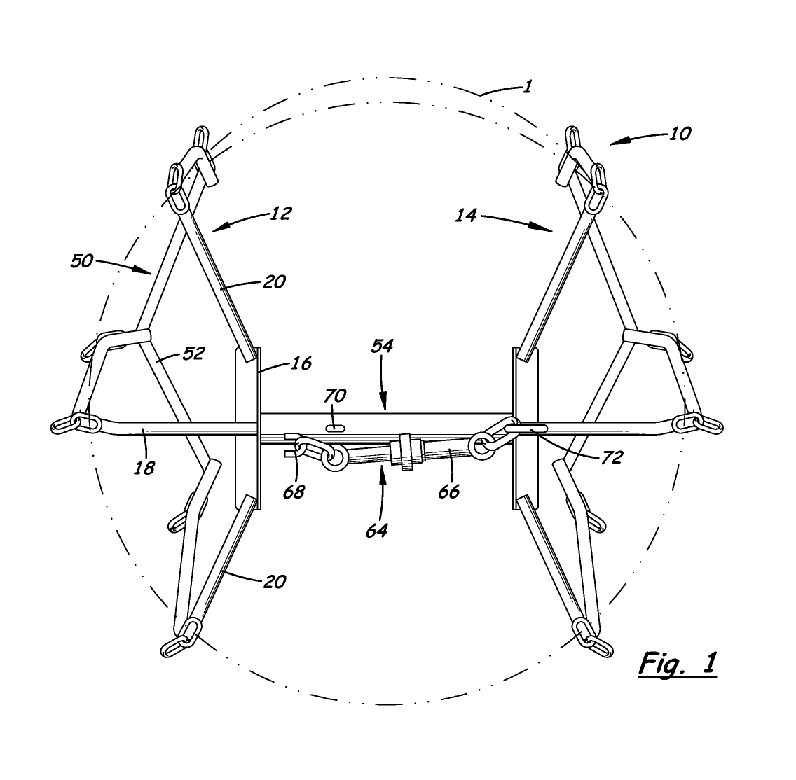

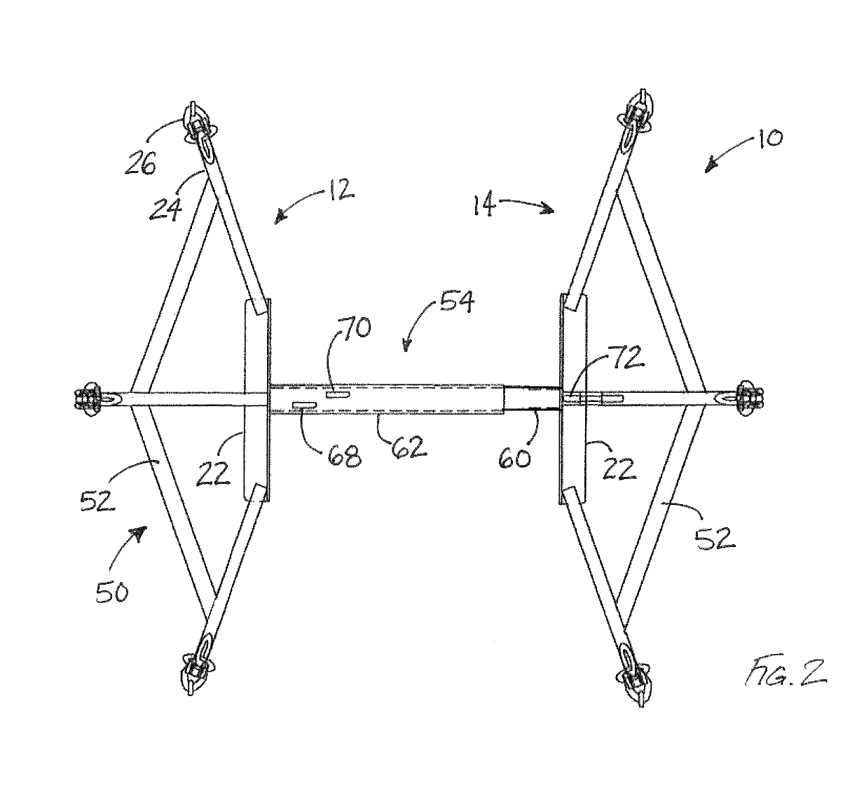

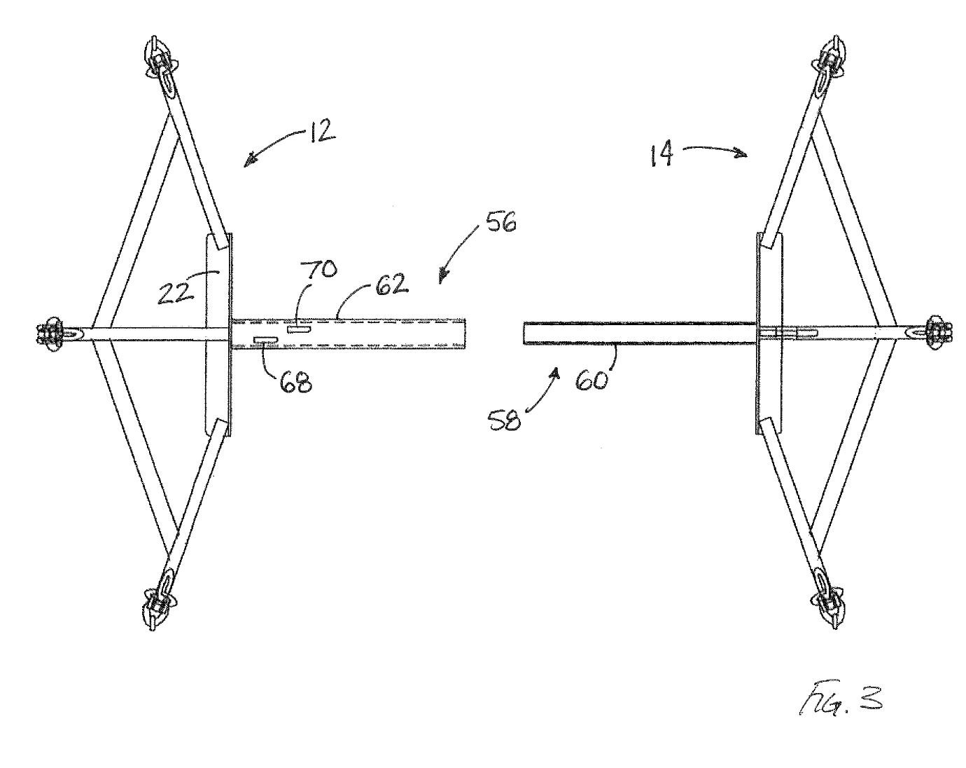

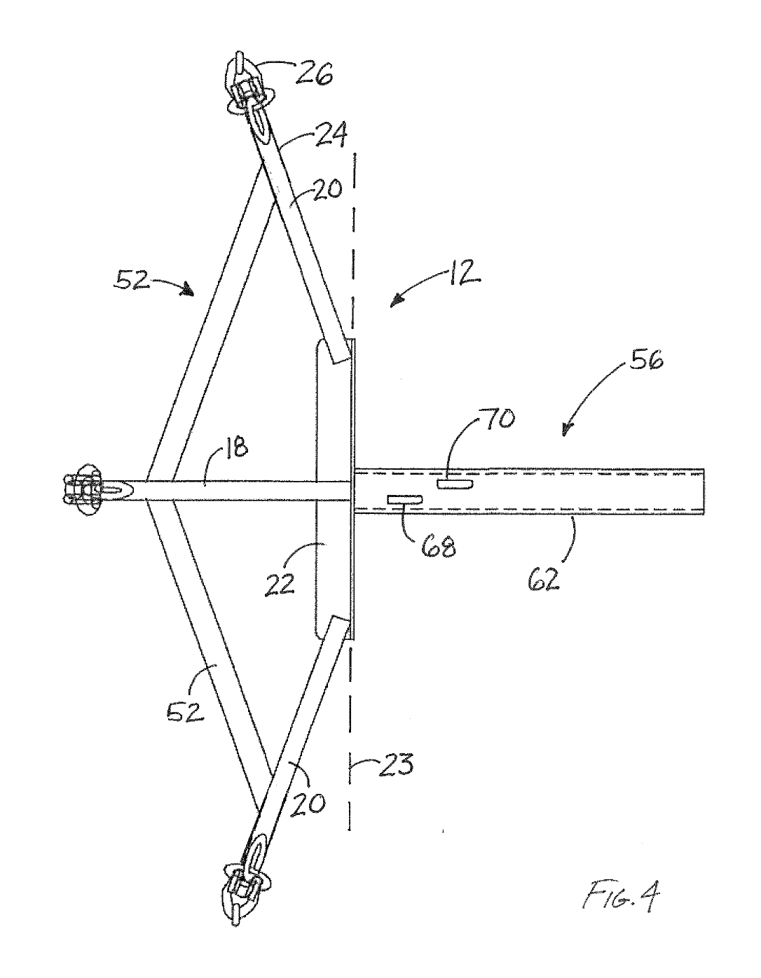

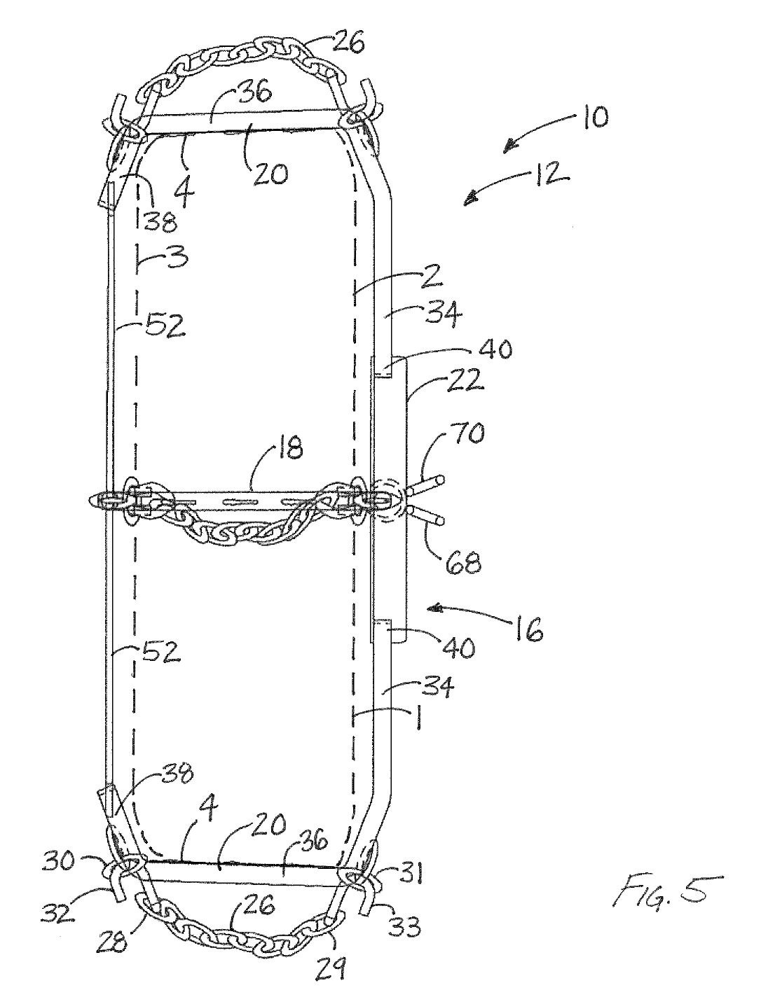

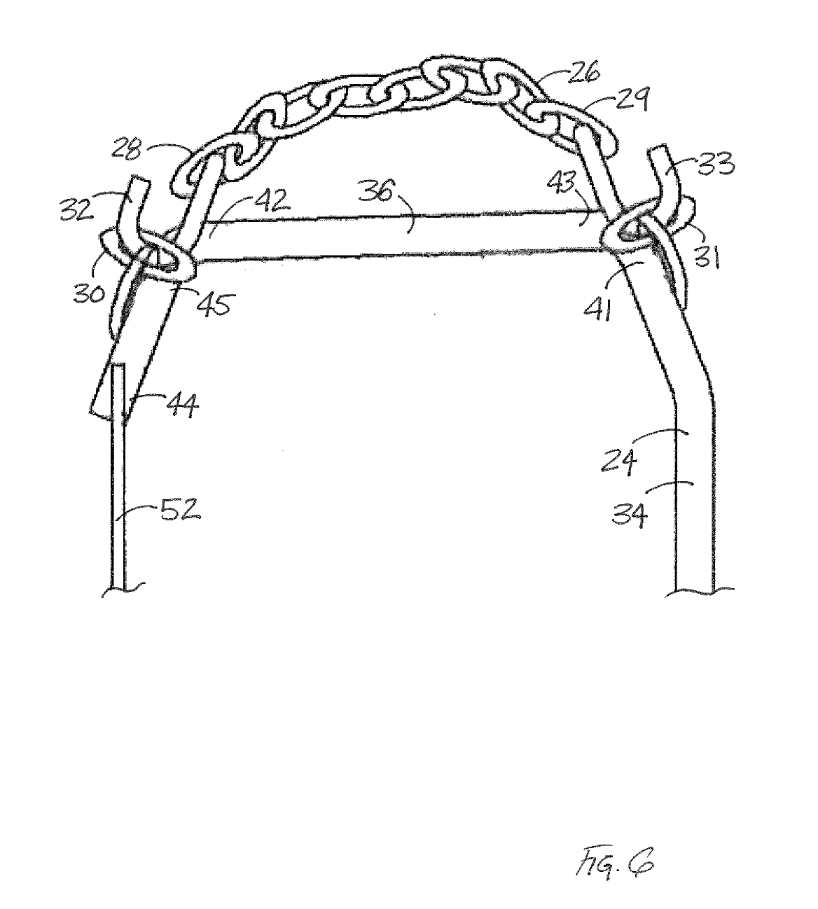

With reference now to the drawings, and in particular to FIGS. 1 through 6 thereof, a new wheel traction enhancement device embodying the principles and concepts of the disclosed subject matter will be described.

The disclosure relates to a traction enhancement device 10 for mounting on a wheel 1 of a vehicle to increase the traction available to the wheel to free the wheel from slipping on a slippery surface such as a surface comprising ice or mud. The wheel 1, which may comprise a tire mounted on a rim, has an outward side surface 2, an inward side surface 3, and a circumferential surface 4 extending generally between the outward 2 and inward 3 side surfaces and being substantially cylindrical in shape. The outward side of the wheel is away from the vehicle, and is typically the side which is accessible by a user of the device 10 and is the side from which the device will be installed on the wheel. The inward side of the wheel is typically toward the vehicle on which the wheel is mounted, and is also typically oriented toward the axle of the vehicle. Typically, the circumferential surface 4 has tread formed thereon.

The device 10 may comprise a pair of traction assemblies 12, 14 for removably mounting on the wheel 1. The traction assemblies 12, 14 may have similar, although not identical, configurations. The traction assembles 12, 14 are generally connectable together in an adjustable manner to clamp onto the wheel at various locations located along the circumferential surface of the wheel.

In greater detail, each of the traction assemblies 12, 14 may comprise a central structure 16 and a plurality of traction structures 18, 20. The central structure 16 of each traction assembly may be positioned adjacent to the center of the outward side surface 2 of the wheel 1. The central structure 16 may comprise an elongated element 22 with a longitudinal axis 23. In the illustrative embodiments, the elongated element is formed of an angle, although other configurations may be used.

The plurality of traction structures 18, 10 may be mounted on the central structure 16 and on the elongated element 22. Each of the traction structures may be mounted on the structure 16 so that it radiates outwardly from the central structure. One of the traction structures comprises a primary traction structure 18 that extends from the central structure, and may extend in an orientation that is substantially perpendicular to the longitudinal axis of the central structure. At least one of the traction structures may comprises a secondary traction structure 20, and in the illustrative embodiment, a pair of the secondary traction structures 20 is utilized. The secondary traction structures 20 may be positioned on opposite sides of the primary traction structure 18. The secondary traction structures 20 radiate from the central structure at an angle to the primary traction structure and to the longitudinal axis of the elongated element of the central structure, and preferably, although not critically, each of the secondary tractions structures is oriented at a similar angle with respect to the primary traction structure and the central structure. At least one of the secondary traction structures is positioned at an angle with respect to the primary traction structure between approximately 45 degrees to approximately 75 degrees.

Optionally, the secondary traction structures 20 may be pivotally mounted on the central structure 16 to permit the secondary traction structures to be moved between a deployed position, in which the secondary traction structure is oriented at the angle with respect to the primary traction structure, and a storage position in which the secondary traction structure is oriented substantially parallel to the primary traction structure. This pivotal movement into the storage position provides a more compact size for the device and thus easier and more convenient storage.

At least one of the traction structures 18, 20 includes a rigid element 24 that is configured to be positioned adjacent to the circumferential surface of the wheel 1 when the device 10 is mounted on the wheel and a flexible element 26 that is positioned along a portion of the rigid element 24 to also be positioned adjacent to the circumferential surface of the wheel when the device is mounted on the wheel. The rigid element 24 may be used to exert inward radial pressure, or a clamping force, on the circumferential surface of the wheel, as the traction assemblies are moved closer to each other. The flexible element 26 may have a character, such as an outer surface, that provides enhanced resistance to slippage when pressed against a slippery surface.

In some of the most preferred embodiments, the flexible element 26 with enhanced slippage resistance comprises a chain, such as a chain having a plurality of interlinked substantially oval links. The chain of the flexible element 26 may have opposite ends 28, 29, and the opposite ends may be removably mounted on the rigid element to permit interchangeable mounting of different types of chains on the rigid element. At least a pair of loops 30, 31 may be mounted on the rigid element 24 at spaced locations from each other, and in some implementations, each of the loops comprises a pair of links with one link being attached, such as by welding, to the rigid element. The chain of the flexible element may include a hook 30, 31 mounted on each of the opposite ends 28, 29 of the chain to engage one of the loops 28, 29 to removably mount the chain of the flexible element to the rigid element. The chain of the flexible element 26 may have a degree of slack when the hooks are engaged to the loops.

At least one of the traction structures 18, 20 may comprise a rigid element 24 that includes a radiating portion 34 for positioning adjacent to the outward side surface of the wheel when the device is mounted on a wheel, a transverse portion 36 for positioning adjacent to the tread portion of the circumferential surface of the wheel, and a return portion 38 for positioning adjacent to the inward side surface of the wheel. In some greater detail, the radiating portion 34 has an inboard end section 40 attached to the central structure 16 and an outboard end section 41. The radiating portion 34 may generally lie in a plane with the longitudinal axis 23 of the central structure 16. The transverse portion 36 may be oriented substantially perpendicular to the radiating portion 34, and may have an outer end section 42 and an inner end section 43 that is attached to the radiating portion 34. The return portion 38 may be oriented substantially perpendicular to the transverse portion 36 and may be oriented substantially parallel to the radiating portion 34. The return portion 38 may have an inboard end section 44 and an outboard end section 45 that is attached to the transverse portion 36. In the illustrative embodiments, the outboard end section 41 of the radiating portion 34 may be tilted inwardly toward the return portion 38 and the outboard end section 45 of the return portion 38 may be tilted inwardly toward the radiating portion 34.

The traction enhancement device 10 may also include a connection structure 50 that connects the traction structures 18, 20 together. The connection structure 50 may be configured to be positioned adjacent to the inward side surface 3 of the wheel when the device is mounted on a wheel. The connection structure 50 may include a connecting member 52 connected to at least two of the traction structures 18, 20. Each of the connecting members 52 may each be connected to a pair of the traction structures 18, 20, and may be connected to the return portions 38 of the respective traction structures. In some embodiments, the connecting members are rigid to hold the return portions 38 in portions with respect to each other. Optionally, the connecting members 52 may be flexible in character, such as, for example, when the traction structures 18, 20 are pivotable with respect to the central structure 16 as described previously.

The device 10 may also include an adjustable mounting structure 54 for releasably mounting the traction assemblies together that permits the adjustment of the distance between the central structures of the traction assemblies 12, 14 when the device 10 is mounted on a wheel to adjust the device to different wheel diameter sizes. The mounting structure 54 may include a first mounting portion 56 mounted on a first traction assembly 12, and a second mounting portion 58 mounted on a second traction assembly 14 and that is configured to engage the first mounting portion. The first mounting portion may comprise a post 60 that extends from the first traction assembly 12, and may be mounted on the central structure 16 of the assembly 12. The second mounting portion 58 may extend from the second traction assembly, and may also extend from the central structure of that assembly 14. The second mounting portion 58 may comprise a tubular structure or tube 62 having an interior for receiving a portion of the post 60 of the first mounting portion to align the first 12 and second 14 traction assemblies as the assemblies are moved toward and away from each other.

A biasing structure 64 may be employed for biasing the traction assemblies 12, 14 toward each other by applying an inwardly directed force on the traction assemblies to bias the traction structures together. The biasing structure 64 may be connected to each of the traction structures 12, 14. The biasing structure 66 may be mounted on the adjustable mounting structure 54, and may be mounted on the first 56 and second 58 mounting portions of the mounting structure. The mounting of the biasing structure on the mounting portions may permit removal of the biasing structures from those portions. In some embodiments, the biasing structure 64 may be removably mountable to one of the mounting portions in at least two different locations along the portion to adjust the degree of biasing force to be applied to the traction assemblies.

In the illustrative embodiments, the biasing structure 64 may include a biasing element 66 that may extend generally along the adjustable mounting structure 54. The biasing element may act to bias the adjustable mounting structure by contracting the length of the biasing element, and thus pulling the portions of the mounting structure toward each other. In some embodiments of the device 10, the biasing element 66 comprises a load binder, and may be of the type of load binder known as a ratchet load binder, that pulls the ends of the load binder closer together as force is applied to the handle of the load binder. The load binder may provide a significant mechanical advantage for biasing and moving the traction assemblies together, particularly where the load binder utilizes a lever arm to actuate the ratcheting binder. Further, the biasing element 64 may provide a high degree of adjustability of the force that is applied to the traction assemblies, and in some application the magnitude may be increased substantially continuously with many degrees of adjustment of the magnitude may be available to be selected by the user. The biasing element 66 may be mounted on the adjustable mounting structure, or the central structure of the respective tractions assemblies, by two or more mounts. Illustratively, a pair of mounts, including a first mount 68 and a second mount 70, are mounted on the first mounting portion 56, and a third mount 72 is mounted on the second mounting portion 58. The first 68 and second 70 mounts may be positioned on the first mounting portion 56 at different distances from the central structure thereof, and correspondingly, different distances from the end of the tube 62 of the second mounting portion. The first and second mounts may also be circumferentially offset from each other such that the second mount does not interfere with mounting the biasing structure to the first mount. Each of the mounts 68, 70, 72 may comprise a hook that is adapted to engage a loop on one of the ends of the biasing element 66.

In the traction enhancement device 10, the traction assemblies 12, 14, and in particular the rigid elements 24 of the traction structures, are able to apply a significant inward radial force on the circumferential surface of the wheel (which in many applications will be a pneumatic tire) to hold the device 10 in place on the wheel without rotation of the wheel with respect to the device. In some cases, the transverse portion 36 of the rigid element may not sufficiently enhance the traction of the wheel, and in these cases the presence of the flexible element 26 positioned adjacent the rigid element, and the transverse portion of the rigid element, provides even greater traction. The greater traction of the flexible may be provided by a length of chain, so that the traction benefit of tire chains is made available without the inherent difficulty of installing and using traditional tire chains.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

I claim:

1. A traction enhancement device for mounting on a wheel of a vehicle, the wheel being of the type having an outward side surface, an inward side surface, and a circumferential surface between the outward and inward side surfaces, the device comprising:
a pair of traction assemblies for removably mounting on a wheel, each of the traction assemblies comprising a central structure for positioning adjacent to a center of the outward side surface of the wheel and a plurality of traction structures mounted on the central structure and radiating outwardly from the central structure;
an adjustable mounting structure for releasably mounting the traction assemblies together, the adjustable mounting structure being configured to permit adjustment of a distance between the central structures of the traction assemblies; and
a biasing structure configured to selectively apply an inwardly directed force on the traction assemblies to bias the traction structures toward each other and against the circumferential surface of the wheel when mounted on the wheel;
wherein at least one of the traction structures includes a rigid element configured to be positioned adjacent to the circumferential surface of the wheel when the device is mounted on the wheel and a flexible element positioned along a portion of the rigid element to be positioned adjacent to the circumferential surface of the wheel when the device is mounted on the wheel.

2. The device of claim 1 wherein the flexible element is removably mounted on the rigid element.

3. The device of claim 1 wherein the flexible element comprises a chain.

4. The device of claim 3 wherein the chain has opposite ends mounted on the rigid element.

5. The device of claim 3 wherein the chain has opposite ends removably mounted on the rigid element to permit interchangeable mounting of different types of chains on the rigid element.

6. The device of claim 5 wherein at least a pair of loops is mounted on the rigid element at spaced locations, and the chain includes a hook mounted on each opposite end of the chain to engage one of the loops.

7. The device of claim 3 wherein the chain is mounted on the rigid element in a manner providing a degree of slack in the chain.

8. The device of claim 1 wherein the biasing structure is removably connected to each of the traction structures.

9. The device of claim 1 wherein the biasing structure acts to adjust the adjustable mounting structure.

10. The device of claim 1 wherein an end of the biasing structure is removably mounted on at least two different locations on the mounting structure to adjust a degree of biasing force to be applied to the traction assemblies.

11. The device of claim 1 wherein the rigid element of one of the traction structures comprises:
a radiating portion for positioning adjacent to the outward side surface of the wheel when the device is mounted on a wheel;
a transverse portion for positioning adjacent to the tread portion of the circumferential surface of the wheel when the device is mounted on a wheel, the transverse portion being oriented substantially perpendicular to the radiating portion; and
a return portion for positioning adjacent to the inward side surface of the wheel when the device is mounted on the wheel, the return portion being oriented substantially perpendicular to the transverse portion and being oriented substantially parallel to the radiating portion.

12. The device of claim 1 additionally comprising a connection structure connecting return portions of the rigid elements of at least two of the traction structures of one of the traction assemblies together.

13. The device of claim 1 wherein the central structure comprises an elongated element having a longitudinal axis; and
wherein one of the traction structures comprises a primary traction structure extending from the central structure and at least one of the traction structures comprises a secondary traction structure, the secondary traction structure radiating from the central structure at an angle to the primary traction structure.

14. The device of claim 13 wherein the angle measures between approximately 45 degrees to approximately 75 degrees.

15. The device of claim 1 wherein the adjustable mounting structure includes a first mounting portion mounted on a first one of the traction assemblies; and
a second mounting portion mounted on a second one of the traction assemblies and configured to engage the first mounting portion;
wherein the first mounting portion comprises a post and the second mounting portion comprises a tube removably receiving a portion of the post.

16. A traction enhancement device for mounting on a wheel of a vehicle, the wheel being of the type having an outward side surface, an inward side surface, and a circumferential surface between the outward and inward side surfaces, the device comprising:
a pair of traction assemblies for removably mounting on a wheel, each of the traction assemblies comprising a central structure for positioning adjacent to a center of the outward side surface of the wheel and a plurality of traction structures mounted on the central structure and radiating outwardly from the central structure;
an adjustable mounting structure for releasably mounting the traction assemblies together, the adjustable mounting structure being configured to permit adjustment of a distance between the central structures of the traction assemblies; and
wherein at least one of the traction structures includes a rigid element configured to be positioned adjacent to the circumferential surface of the wheel when the device is mounted on the wheel, and a flexible element positioned along a portion of the rigid element to be positioned adjacent to the circumferential surface of the wheel when the device is mounted on the wheel;
wherein the flexible element comprises a chain removably mounted on the rigid element to permit interchange of the flexible element on the rigid element.

17. The device of claim 16 wherein the chain is mounted on the rigid element in a manner providing a degree of slack in the chain.

18. The device of claim 16 additionally comprising a biasing structure configured to selectively apply an inwardly directed force on the traction assemblies to bias the traction structures toward each other and against the circumferential surface of the wheel when mounted on the wheel.
